(19) United States
(12) Patent Application Publication
(10) Pub. No.: US 2017/0121189 A1
(43) Pub. Date: May 4, 2017

(54) DEVICE WITH FLAT MEMBRANES FOR WATER PURIFICATION

(71) Applicant: KING FAHD UNIVERSITY OF PETROLEUM AND MINERALS, Dhahran (SA)

(72) Inventors: Faizur Rahman, Dhahran (SA); Tahar Laoui, Dhahran (SA)

(73) Assignee: KING FAHD UNIVERSITY OF PETROLEUM AND MINERALS, Dhahran (SA)

(21) Appl. No.: 14/926,488

(22) Filed: Oct. 29, 2015

(51) Int. Cl. C02F 1/44

(52) U.S. Cl. CPC C02F 1/441; C02F 2101/10

(57) ABSTRACT

A desalination cell which works with flat membranes for water purification purposes. A feed fluid is stirred on a feed side of the membrane to minimize cake formation. A purified liquid is formed on the permeate side of the membrane, and a reject fluid formed on the feed side of the membrane. When thick ceramic membranes are used, the desalination cell can be adapted to have a sealing gasket around the circumference of the membrane to prevent the feed fluid from by-passing the membrane and contaminating the purified fluid.

### BACKGROUND OF THE INVENTION

Technical Field

The present invention relates to a device having a flat membrane for purifying water under cross-flow conditions.

Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Membrane separation processes operate without heating, and therefore use less energy than conventional thermal separation processes such as distillation, sublimation, or crystallization. In particular, pressure driven operations, such as microfiltration, ultrafiltration, nanofiltration, and reverse osmosis, are widely used. One can find them in household drinking water purification systems, food industry, portable water purification units for military use, waste water treatment plants, and desalination plants.

Membrane fouling, however, degrades the performance of the membrane. When the membrane cannot be replaced easily, the performance of the membrane can be restored by regular cleaning with chemicals or rigorous backwashing. These processes are time-consuming, and they can alter the pore structures of polymeric membranes, which are vulnerable to organic solvents and heat treatment. Compared to polymeric membranes, ceramic membranes have better antifouling properties, in addition to being more chemically and thermally stable (Guizard C., Ayral A., Julbe A. Potentiality of organic solvents filtration with ceramic membranes. A comparison with polymer membranes. Desalination 2002, 147, 275-280; Lobo A., Cambiella A., Benito J. M., Pazos C., Coca J. Ultrafiltration of oil-in-water emulsions with ceramic membranes: Influence of pH and cross-flow velocity. Journal of Membrane Science 2006, 278, 328-334—each incorporated herein by reference in its entirety). They are, however, heavier and less economical than polymeric membranes.

Therefore, there is a growing interest in developing and testing new membranes that are economical and have good antifouling properties.

Some common membrane test devices, Sterlitech HP 4750 and AMS HPC 197, test membranes under dead-end filtration, which does not simulate the dynamics of the cross-flow filtration in a full-size system (Cosack, C. et al. U.S. Pat. No. 4,137,756 A; RAJAGOPALAN, N. et al. U.S. patent application Ser. No. 10/364,244—each incorporated herein by reference in its entirety). Membrane test devices that are compatible with cross-flow filtration work only with flat polymeric membranes that are thinner than 0.2 mm (BERTELSEN, R. et al. U.S. Pat. No. 4,846,970; LIEVEN, G. et al. U.S. Pat. No. 7,818,996 B2—each incorporated herein by reference in its entirety). These devices cannot be adapted to test ceramic membranes, which are usually more than 1 mm thick. Likewise, ceramic membrane test devices cannot be adapted to test thin polymeric membranes.

The SEPA CF II cell is a cross-flow filtration unit that tests large flat membranes with a surface area of 140 cm². Although it is compatible with the commercially available polymeric membranes, it is not suited to screen new membranes, which are usually made in small sizes to consume less material.

Manjikian (MANJIKIAN, S. U.S. Pat. No. 3,674,152 A—incorporated herein by reference in its entirety) disclosed a membrane test device lacking a stirrer, which is an essential component in minimizing cake formation on the membrane, and hence affects the performance of the membrane.

In view of the foregoing, the objective of the present invention is to provide a desalination cell that can be used for water purification and a water purification method using the desalination cell.

### BRIEF SUMMARY OF THE INVENTION

According to a first aspect, the present disclosure relates to a desalination cell that purifies the feed fluid under cross-flow filtration. The desalination cell has (i) a vessel with a bottom portion and a top cover, and the bottom portion attaches to the top cover to enclose a first interior space, (ii) a fluid inlet attached to the top cover to fill the first interior space with a feed fluid to be purified, (iii) a fluid outlet attached to the top cover to remove a reject fluid from the first interior space, (iv) a fluid-tight interior unit, which has (1) a membrane to purify the feed fluid to form a purified fluid, (2) a stirring device to mix the feed and reject fluids, and to reduce caking on a feed side of the membrane, (3) a first perforated plate to support the stirring device, and the first perforated plate is fluidly connected to a feed side of the membrane, (4) a second perforated plate to support the membrane, which is disposed between the first perforated plate and the second perforated plate, and wherein a permeate side of the membrane is fluidly connected to a first side of the second perforated plate, and a second side of the second perforated plate and interior walls of the vessel enclose a second interior space to contain the purified fluid, (v) a purified fluid outlet that fluidly connects the second interior space to a receptacle.

In one embodiment, the fluid inlet and the fluid outlet are disposed on a side face of the top cover, and the purified fluid outlet is disposed on a side face of the bottom portion.

In another embodiment, the fluid inlet and the fluid outlet are disposed on a top face of the top cover, and the purified fluid outlet is disposed on a bottom face of the bottom portion.

In one embodiment, a sealing member is sandwiched between the top cover and the bottom portion of the vessel.

In one embodiment, a gas inlet is disposed on the top cover for adding gas so as to pressurize the first interior space and promote production of the purified fluid.

In another embodiment, a vacuum port is disposed on the bottom portion of the vessel to create a low pressure region in the second interior space and a high pressure region in the first interior space to promote production of the purified fluid.

In at least one embodiment, the feed fluid is a brine solution.

In at least one embodiment, the cell is disposed on a magnetic stir plate to spin the stirring device, which is a magnet, to stir the feed fluid and the reject fluid.

In one embodiment, the membrane is a reverse osmosis desalination membrane.

In at least one embodiment, the membrane is made of a polymer or a ceramic material.

In one embodiment, the ceramic membrane comprises carbon nanotubes.

In one embodiment, a diameter of the membrane is 70-95% relative to a largest inner diameter of the bottom portion of the vessel.

In at least one embodiment, the membrane is flat.

In one embodiment, the membrane is a ceramic membrane and has a thickness that is 1-10% relative to a height of the cell.

In one embodiment, the desalination cell also includes a sealing member with an inner surface in contact with a circumference of the membrane and an outer surface in contact with the interior walls of the vessel to prevent fluid leakage.

In one embodiment, the sealing member is a gasket.

According to a second aspect, the disclosure relates to a water purification method involving (i) filling the interior space of the desalination cell in one or more of its embodiments with the feed fluid through a fluid inlet, (ii) stirring the feed fluid and the reject fluid with the stirring device, (iii) filtering the feed fluid with the membrane, wherein the feed fluid flows through the feed side of the membrane to produce the purified fluid on a permeate side of the membrane and the reject fluid on a feed side of the membrane, (iv) collecting the purified fluid in a receptacle, and (v) removing the reject fluid through a fluid outlet.

In at least one embodiment, the method further comprises adding gas to the interior space to pressurize the first interior space and promote production of the purified fluid.

In one embodiment, the method further comprises evacuating the second interior space to form a low pressure region in the second interior space and a high pressure region in the first interior space to promote production of the purified fluid.

In at least one embodiment, the method further comprises spinning the stirring device, which is a magnet, with a magnetic stir plate.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram of a desalination setup according to the present invention.

FIG. 2A is a diagram of one of the embodiments of the desalination cell.

FIG. 2B is a top view of the top cover.

FIG. 2C is a side view of the top cover.

FIG. 2D is a side view of the bottom portion.

FIG. 3 is a partially expanded view of one embodiment of the desalination cell.

FIG. 4A is a top view of a perforated plate.

FIG. 4B is a side view of a perforated plate.

FIG. 5A is a top view of a spacer.

FIG. 5B is a side view of a spacer.

FIG. 6A is a partially expanded cross-section view to illustrate the seal around a thick ceramic membrane.

FIG. 6B is a cross-section view to illustrate the seal around a thick ceramic membrane.

### DETAILED DESCRIPTION OF THE EMBODIMENTS

Embodiments of the present disclosure will now be described more fully hereinafter with reference to the accompanying drawings, in which some, but not all embodiments of the disclosure are shown. Referring now to the drawings, wherein like reference numerals designate identical or corresponding parts throughout the several views.

It must be noted that, as used in the specification and the appended claims, the singular forms “a,” “an,” and “the” include plural referents unless the context clearly dictates otherwise.

For polygonal shapes, the term “diameter”, as used herein, and unless otherwise specified, refers to the greatest possible distance measured from a vertex of a polygon through the center of the face to the vertex on the opposite side. For a circle, an oval, and an ellipse, “diameter” refers to the greatest possible distance measured from one point on the shape through the center of the shape to a point directly across from it.

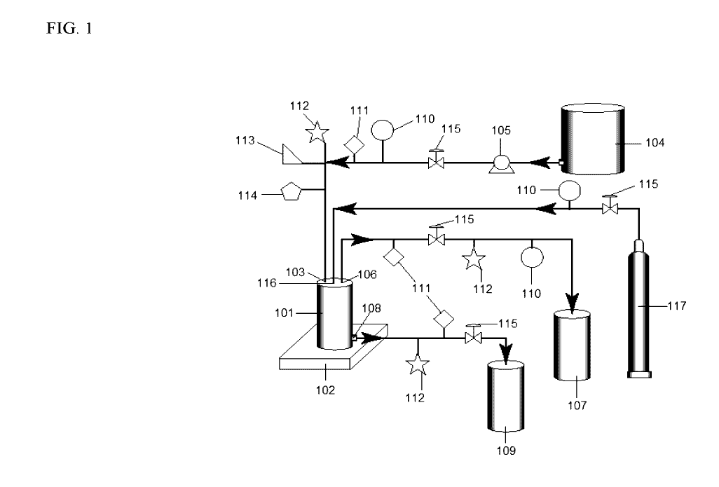

The present disclosure relates to a desalination cell 101, shown in FIGS. 1 to 3, which can be used to purify water with thin polymeric membranes as well as thick ceramic membranes. The water purification setup is shown in FIG. 1. In addition, the desalination cell can test membranes under cross-flow filtration conditions that are similar to those employed in practical applications. As used herein, the term “desalination” refers to a process for removal of salts and minerals from a feed fluid in order to produce potable water that is safe for not only ingestion but also a variety of domestic and industrial uses.

The desalination cell is a cuboid or, preferably, cylindrical. The height is 5-30 cm, preferably 5-25 cm, more preferably 5-20 cm. The outer diameter of the cell is 5-30 cm, preferably 5-20 cm, more preferably 5-15 cm. The inner diameter of the cell is 1.5-28 cm, preferably 2-18 cm, more preferably 2-13 cm. The capacity is 50-500 ml, preferably 50-300 ml, more preferably 50-250 ml. The desalination cell is easy to fabricate and assemble, and is scalable. It is envisioned that the cell be incorporated into a household water purification system, where the cell has a volume of 0.5-5 L, preferably 0.5-3 L, more preferably 0.5-2 L, or in desalination plants, where the cell has a volume of 50-500 m³, preferably 100-400 m³, more preferably 100-200 m³.

The cell has a vessel made of a material including, but not limited to, glass, polypropylene, polyvinyl chloride, polyethylene, and/or Teflon. In a preferred embodiment, the vessel is made of stainless steel. The vessel has a top cover 201 attached to a bottom portion 202 to enclose a first interior space 203. In one embodiment, the height of the top cover is 3-30% relative to the height of the cell, preferably 3-20%, more preferably 3-10%. In one embodiment, the top cover is connected to the bottom portion using high pressure clamps. In a preferred embodiment, the top cover is connected to the bottom position with screws 204. In at least one embodiment, there is a seal 205 sandwiched between the cover and the bottom portion. The seal is made of a material including, but not limited to, rubber, ethylene-propylene, silicone, and fluoropolymers. In a preferred embodiment, the seal is made of viton. In at least one embodiment, the seal is a gasket. In a preferred embodiment, the seal is an O-ring. The shape of the first interior space depends on the general shape of the vessel. For example, when the vessel is in the form of a cylinder, then the interior space is in the form of a cylinder.

The vessel houses a stirring device 206 to mix a feed fluid and a reject fluid in order to prevent cake formation on a feed side of a membrane 301. The stirrer is preferably positioned as close as possible to the membrane surface, while still eliminating the risk of membrane damage. The distance between a bottom of the stirrer device and the feed side of the membrane is preferably 0.1-2 cm, preferably 0.2-1.5 cm, more preferably 0.4-1 cm. In one embodiment, the stirring device is a shaft with a propeller-shaped blade on a first end immersed in the mixture of the feed and reject fluids, and a second end inserted into a mechanical stirrer. The stirring device is disposed in a way that a longitudinal axis of the stirring device coincides with a centrally disposed vertical axis through the vessel, with the propeller-shaped blade disposed towards the feed side of the membrane and the second end of the shaft disposed towards the top cover. In another embodiment, the stirring device is disposed at an offset from the centrally disposed vertical axis of the vessel. In a preferred embodiment, the stirring device is a magnet. The length of the magnet is 60-90% relative to a largest inner diameter of the vessel, preferably 70-85%, more preferably 70-80%. In at least one embodiment, the magnet is coated with PTFE. In another embodiment, the magnet is coated with borosilicate glass. The shapes of the magnet include, but not limited to, star head, cross, cylinder, star-shaped, and polygon-shaped bar. In a preferred embodiment, the magnet is an octagonal bar. In one embodiment, the cell rests on a magnetic stir plate 102 to spin the magnet. In another embodiment, the cell is clamped at a height above the magnetic stir plate. The magnet may be stirred with the magnetic stir plate at various stirring speeds depending on the amount of, or the tendency of a feed to cause membrane fouling. In one embodiment, the stirring speed is 200-1000 rpm, preferably 200-700 rpm, more preferably 200-400 rpm.

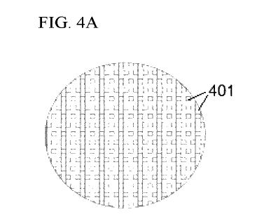

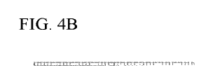

The magnet is supported on a first perforated plate 207. The first perforated plate is made of a material selected from, but is not limited to, aluminum, brass, and polymers. Examples of polymers include, but are not limited to, rubber, ethylene-propylene, silicone, and fluoropolymers. In a preferred embodiment, the first perforated plate is made of stainless steel. The shape of the first perforated plate includes, but is not limited to, a square, a rectangle, an ellipse, and an oval, and is preferably the same shape as a top face of the first interior space. In a preferred embodiment, the first perforated plate is round. The diameter of the first perforated plate is 95-100% relative to the inner diameter of the cell, preferably 97-100%, more preferably 99-100%. The thickness of the plate is preferably 0.1-1% relative to the height of the cell, preferably 0.1-0.8%, more preferably 0.1-0.5%. In at least one embodiment, the first perforated plate has a plurality of holes 401 with diameters 1-10% relative to the diameter of the perforated plate, preferably 1-8%, more preferably 1-5% (FIGS. 4A and 4B). The porosity of the first perforated plate ranges from 50-90%, preferably 60-85%, more preferably 70-80%. The shape of the holes includes, but is not limited to, a circle, an oval, an ellipse, a triangle, a square, a rectangle, a pentagon, a hexagon, an octagon, a star, and a cross. In some embodiments, the first perforated plate is a baffle plate with a plurality of vanes for directing the flow of the feed fluid. In one embodiment, the vanes are V-shaped. In another embodiment, the vanes are U-shaped. The distance between each vane is 0.01-10% relative to the diameter of the baffle plate, preferably 0.05-5%, more preferably 0.1-2%. In another embodiment, the magnet is stationary, and the flow of the fluid drives the rotation of the baffle plate.

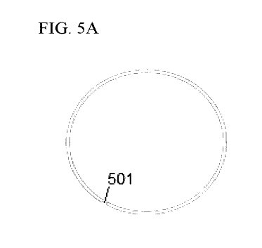

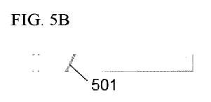

To minimize the possibility of the stirring device scratching the inner walls of the cell, a first spacer 208 rests on the first perforated plate to form a fence around the stirring device. The first spacer is made of a polymer including, but not limited to, rubber, ethylene-propylene, silicone, and preferably, fluoropolymers. The shape of the first spacer may be, but is not limited to, a square, a rectangle, an ellipse, and an oval, and is preferably the same shape as a top face of the first interior space. In a preferred embodiment, the spacer is round. The inner diameter of the first spacer is 90-100% relative to the inner diameter of the cell, preferably 95-99%, more preferably 97-99%. The outer diameter of the first spacer is 90-100% relative to the inner diameter of the cell, preferably 95-100%, more preferably 97-100%. The height of the first spacer is 1-10% relative to the height of the cell, preferably 1-8%, more preferably 2-7%. In a preferred embodiment, the height of the spacer is 0.1-1.5 cm, preferably 0.2-1.2 cm, more preferably 0.5-1 cm. In one embodiment, the spacer is a continuous ring. In another embodiment, the spacer has a slit 501 through the spacer, angled at 45-90° relative to the horizontal, preferably 60-90°, more preferably 75-90° (FIGS. 5A and 5B). In one embodiment, the first spacer is an O-ring. In a preferred embodiment, the first spacer is a gasket.

A second spacer 209 is disposed beneath the first perforated plate, and rests on the membrane. The second spacer protects the feed side of the membrane from flow disturbance, and also prevents the feed fluid from leaking at the side of the membrane and contaminating the purified fluid. The aforementioned shapes, materials, and dimensions that are relevant to the first spacer also relate to the second spacer.

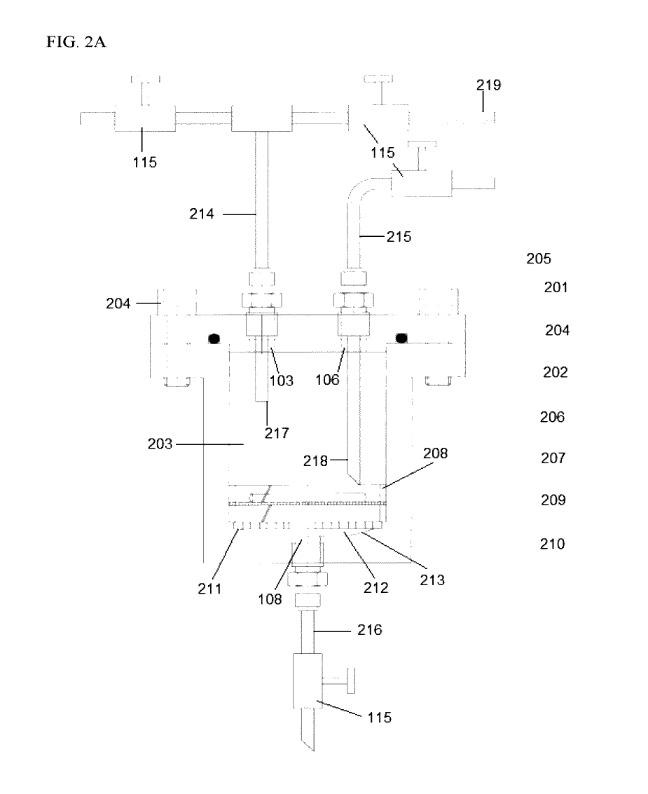

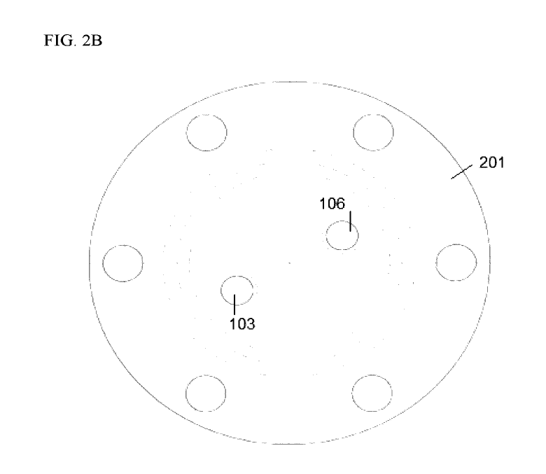

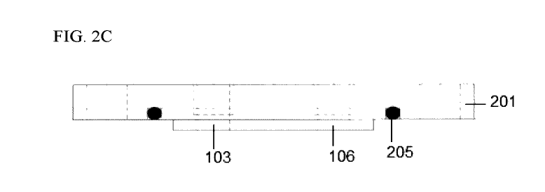

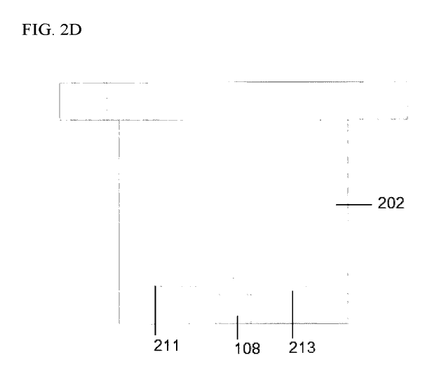

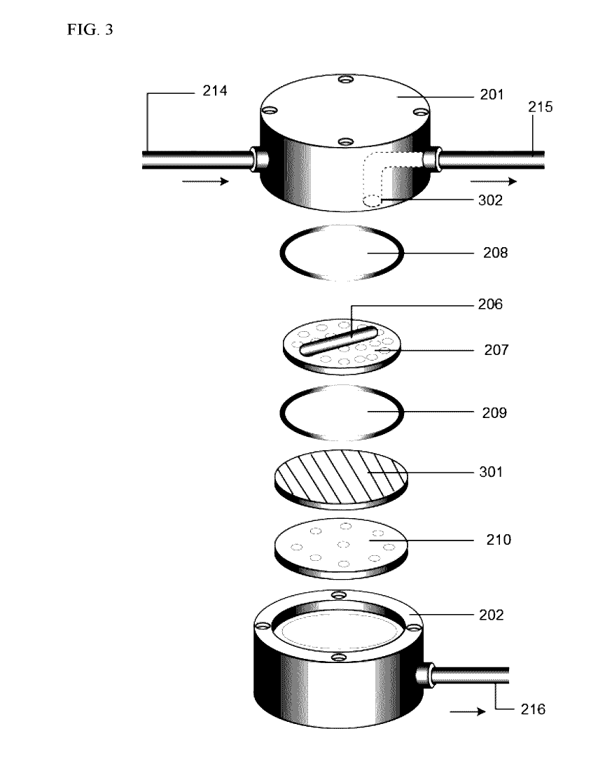

The membrane 301 is disposed with its horizontal plane parallel to the horizontal plane of the first perforated plate (FIG. 3). In one embodiment, shown by FIG. 2A, the membrane is located within the second spacer 209, and thus hidden in this view of the cell. In at least one embodiment, there is one membrane. In one embodiment, there is a stack of a plurality of membranes. Each membrane is preferably separated from one another by a spacer. Examples of the membrane include, but are not limited to, a microfiltration membrane and an ultrafiltration membrane. In one embodiment, a nanofiltration membrane is used. The nanofiltration membrane has a molecular weight cut off of 101-2000 amu, preferably 150-1000 amu, more preferably 150-600 amu. As used herein, the term “molecular weight cut off” refers to the lowest molecular weight solute that is 90% retained by the membrane. The salt rejection is 20-90%, preferably 50-90%, more preferably 70-90%. As used herein, the term “salt rejection” refers to the percentage of salt removed from the feed fluid. Examples of salts include, but are not limited to, chlorides, fluorides, bromides, sulfates, sulfides, nitrates, bicarbonates, and carbonates of sodium, potassium, calcium, magnesium. In a preferred embodiment, a reverse osmosis membrane is used. A reverse osmosis membrane has a molecular weight cut off of 0-100 amu, preferably 0-80 amu, more preferably 0-50 amu. The salt rejection is 90-99.9%, preferably 95-99.9%, more preferably 98-99.9%. In one embodiment, the membrane has an average pore diameter of 0.05-20 nm, preferably 0.05-15 nm, more preferably 0.1-5 nm. The porosity of the membrane ranges from 35-85%, preferably 50-75%, more preferably 60-70%.

In one embodiment, a surface of the membrane is curved. In a preferred embodiment, the surface of the membrane is flat. As used herein, the term “flat” refers to the general shape of the macrostructure of the membrane (i.e. a level surface) and does not refer to a microscopically smooth surface. For example, the membrane may have microscopic wrinkles, pores, bumps, ridges, etc. and still have a substantially “flat” macrostructure. In one embodiment, the membrane has a shape of a square, or a rectangle to match the shape of the top face of the first interior space. In a preferred embodiment, the membrane is round. The diameter of the membrane is 95-100% relative to the inner diameter of the cell, preferably 97-100%, more preferably 99-100%. In a preferred embodiment, the diameter of the membrane is 1-6 cm, preferably 1.5-5.5 cm, more preferably 2-5 cm. In a preferred embodiment, the active surface area of the membrane is 10-60 cm², preferably 10-55 cm², more preferably 15-50 cm².

In one embodiment, a polymer membrane is used. Examples of polymers include, but are not limited to, polyamide, cellulose acetate, urea, polysulfone, polyether sulfone, polyethylene, polyvinylidene fluoride, polyvinyl alcohol, polyacrylonitrile, polyacrylic acid, and polypiperazine amide. In one example, the thickness of the polymer membrane is 10-250 μm, preferably 20-200 μm, more preferably 30-100 μm.

In another embodiment, a thin-film composite membrane is used. A thin layer of a first polymer is coated on a second polymer, and the first polymer is a different polymer from the second polymer. The aforementioned polymers that are relevant to the polymer membrane also relate to the first and second polymers in the thin-film composite membrane. The overall thickness of the thin-film composite membrane is 10-250 μm, preferably 20-200 μm, more preferably 30-100 μm. The thickness of the thin layer of the first polymer is 0.1-5% relative to the overall thickness of the thin-film composite membrane, preferably 0.1-3%, more preferably 0.1-1%.

In a preferred embodiment, a ceramic membrane is used. The ceramic membrane is made of a material selected from a group of metal oxides, nitrides, and carbides, where the metal may be, but is not limited to, aluminum, titanium, silicon, zirconium, and combinations thereof. The overall thickness of ceramic membrane is 0.5-10% relative to the height of the cell, preferably 0.5-5%, more preferably 0.5-3%. The ceramic membrane has an active layer in contact with a support layer. The thickness of the active layer is 1-20% relative to the overall thickness of the ceramic membrane, preferably 5-15%, more preferably 8-13%. In at least one embodiment, the ceramic membrane is symmetric with uniform cylindrical pores throughout the entire thickness of the membrane, with the same pore diameter on the feed side and the permeate side of the membrane. In another embodiment, the ceramic membrane is asymmetric with uniform pores throughout the support layer, and ending in an active layer with gradually reduced pore diameter and increased pore density. In at least one embodiment, the support layer is made of aluminum oxide. In a preferred embodiment, the active layer is made of titanium oxide.

In one embodiment, the membrane contains carbon nanotubes in the pores of the ceramic membrane to enhance the performance of the membrane. As used herein, the term “carbon nanotubes” or “CNTs” refers to allotropes of carbon having an elongated tubular or cylindrical structure or bodies which is typically only a few atoms in circumference. Carbon nanotubes are hollow and typically have a linear fullerene structure and one or more inner walls. The carbon nanotubes may be single-walled nanotubes (SWNTs), multi-walled nanotubes (MWNTs,) or double-walled nanotubes (DWNTs). The diameter of the carbon nanotubes is 0.05-20 nm, preferably 0.05-15 nm, more preferably 0.1-2 nm. The height of the carbon nanotubes is 0.5-500 nm, preferably 5-300 nm, more preferably 50-200 nm.

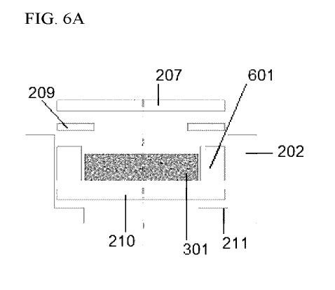

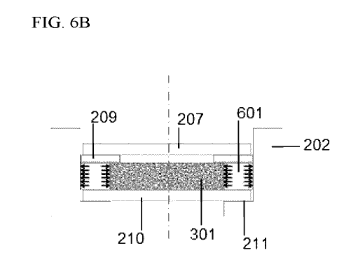

In one embodiment, the ceramic membrane has a diameter 100% relative to the inner diameter of the cell. In a preferred embodiment, the ceramic membrane has a diameter 95-99.9% relative to the inner diameter of the cell, preferably 96-99.5%, more preferably 97-99.5%. There is a sealing member 601 surrounding the membrane, to provide a lateral sealing force (indicated by the arrows) to maintain a fluid tight cell (FIGS. 6A and 6B). The bottom face of the second spacer is in contact with the ceramic membrane and the sealing member, and provides a downward compressive sealing force. In a preferred embodiment, the sealing member is a gasket. The gasket is made of a polymer selected from a group consisting of the aforementioned polymers. In a preferred embodiment, the gasket is made of a fluoropolymer. The inner diameter of the gasket is 97-102% relative to the diameter of the membrane, preferably 98-101%, more preferably 99-100%. The outer diameter of the gasket is 97-100% relative to the inner diameter of the cell, preferably 98-100%, more preferably 99-100%. The thickness of the gasket is 100-110% relative to the thickness of the membrane, preferably 100-108%, more preferably 100-105% so as to be flushed with the feed side of the ceramic membrane when compressed. In another embodiment, the second spacer is absent and the first perforated plate rests on the sealing member.

The membrane is supported on a second perforated plate 210. A first side of the second perforated plate is fluidly connected to the permeate side of the membrane. The aforementioned shapes, materials, and dimensions that are relevant to the first perforated plate also relate to the second perforated plate.

In one embodiment, the second perforated plate rests on the steps 211 on the inner wall. The inner wall and the second perforated plate enclose a second interior space 212 to collect the purified fluid. The height of this interior space is 1-20% relative to the height of the cell, preferably 1-15%, more preferably 1-10%. The walls 213 of the second interior space are at an angle of 10-90° relative to the horizontal, preferably 10-25°, more preferably 10-20°. The bottom of the second interior space has grooves to promote draining of the purified fluid towards the purified fluid outlet of the second interior space. In one embodiment, the purified fluid outlet is located in the center of the second interior space. In an alternative embodiment, the purified fluid outlet is eccentrically located in the second interior space. Examples of grooves include, but are not limited to, U-shaped grooves, V-shaped grooves.

The present disclosure further relates to a method for desalinating a feed fluid with the desalination cell described herein, as well as water purification devices and systems incorporating the desalination cell.

A basic description of the desalination is as follows: the feed fluid passes through the feed side membrane to form a purified fluid on the permeate side of the membrane and a reject fluid on the feed side of the membrane. Examples of the feed fluid that may be treated with the desalination cell include, but are not limited to, seawater, brackish water, wastewater, industrial effluent water, tap water, saline water, and brine. The amount of salt in brine is more than 50 g/L. The amount of salt in saline water ranges from 30-50 g/L. The amount of salt in seawater ranges from 30-40 g/L. The amount of salt in brackish water is 0.5-30 g/L.

In one embodiment, the feed fluid is poured into the vessel. In a preferred embodiment, the feed fluid is introduced into the first interior space via a fluid inlet 103 disposed on the top cover. In at least one embodiment, the fluid inlet is fluidly connected to the feed reservoir containing the feed fluid. In a preferred embodiment, a first tubing 214 connects the fluid inlet to the feed reservoir 104. In one embodiment, the first tubing is attached to the top cover using a tubing adapter with a first end connected to the first tubing and a second end screwed into the top cover. In another embodiment, the first tubing is attached to the top cover using a high pressure clamp and a seal sandwiched between the first tubing and the top cover. The first tubing is made of polymers including, but not limited to, polyvinyl chloride, polyurethane, polyethylene, polypropylene, silicone, and latex. In a preferred embodiment, the first tubing is made of stainless steel. The inner diameter of the first tubing is 1-10%, preferably 1-8%, more preferably 1-5%, relative to the height of the cell. The outer diameter of the first tubing is 1-11%, preferably 1-9%, more preferably 1-6%, relative to the height of the cell. In one embodiment, a pump 105 is used to pump the feed fluid from the reservoir to the vessel.

In at least one embodiment, a fluid outlet 106 is disposed on the top cover. In a preferred embodiment, a first end of a second tubing 215 attaches to the fluid outlet and a second end leads to a first receptacle. The aforementioned materials and dimensions that are relevant to the first tubing also relate to the second tubing. In one embodiment, the first receptacle is the fluid reservoir. In another embodiment, the first receptacle is a waste container 107.

In at least one embodiment, a purified fluid outlet 108 is disposed on the bottom portion of the vessel to fluidly connect the second interior space to a second receptacle. In at least one embodiment, a first end of a third tubing 216 attaches to the second end of the purified fluid outlet, and a second end leads to the second receptacle 109. The aforementioned materials and dimensions that are relevant to the first tubing also relate to the third tubing. In one embodiment, the second end of the third tubing rests in the second receptacle. In one embodiment, the second receptacle is a beaker. In another embodiment, the second receptacle is an Erlenmeyer flask with a ground glass joint. The second end of the tubing is connected to a joint adapter, which fits the ground glass joint on the Erlenmeyer flask to form a closed system.

In one embodiment, the desalination cell is part of a household purification system. In one embodiment, the feed fluid is tap water. The fluid inlet is fluidly connected to the water pipes, and the purified outlet fluidly connected to the faucet. The fluid outlet for the reject fluid is fluidly connected to the discharge pipe.

In one embodiment, the desalination cell is part of a desalination plant. The feed fluid is disinfected with chlorine and pre-treated with alum to coagulate the particles present. The purified fluid is irradiated with ultraviolet rays and treated with ozone to prevent microbial growth.

In at least one embodiment, a fluid inlet and a fluid outlet are attached to the top cover, and a purified fluid outlet is attached to the bottom portion. The orientations of the fluid inlet, fluid outlet, and purified fluid outlet are independent of one another.

In another embodiment, the fluid inlet and outlet are attached to the top of the top cover, and the purified fluid outlet connected to the bottom face of the bottom portion. The flow of the fluid is mostly perpendicular to the membrane with a small portion flowing parallel to the membrane. The distance between a center of the fluid inlet and a center of the fluid outlet is 10-90% relative to the largest inner diameter of the cell, preferably 40-90%, more preferably 70-90%. In one embodiment, a fourth tubing 217 is disposed in the first interior space, and a first end of the fourth tubing is connected to the fluid inlet and the second end is left open. The length of the fourth tubing is 5-20% relative to the height of the cell, preferably 5-15%, more preferably 5-10%. There is a fifth tubing 218 disposed in the first interior space. A first end of the fifth tubing is attached to the fluid outlet, a second end of the tubing is disposed 0.1-2 cm above the first perforated plate, preferably 0.1-1.5 cm, more preferably 0.5-1 cm. The diameters of the fourth and fifth tubings are the same as the diameter of the first tubing. In one embodiment, the second ends of the fourth and fifth tubings are beveled. In another embodiment, the second ends of the fourth and fifth tubings are flat.

In a preferred embodiment, the fluid inlet and the fluid outlet are disposed on a side face of the top cover, located opposite each other, and a purified fluid outlet located on a side face of the bottom portion. A L-shaped tubing 302 is disposed in the first interior space, with a first end of L-shaped tubing connected to the fluid outlet, and a second end left open. The length of the L-shaped tubing is 5-50% relative to the diameter of the cell, preferably 20-50%, more preferably 40-50%. The height of the L-shaped tubing is 50-100% relative to the height of the top cover, preferably 60-90%, more preferably 70-80%. The fluid flow is mostly parallel to the membrane, giving rise to cross-flow filtration. Cross-flow filtration is preferred because it is more relevant to large-scale practical applications and cake formation is minimized.

In another embodiment, the vessel can purify water under dead-end conditions where the fluid outlet is absent. The fluid flow is entirely perpendicular to the membrane.

The desalination cell is designed to allow the user to position and remove a membrane easily. In one embodiment, the user tests a first membrane for 3-24 hours, preferably 3-18 hours, more preferably 3-12 hours under a constant stirring speed. In one embodiment, the feed fluid is pumped into the vessel at a rate of 5-20 L/min, preferably 5-15 L/min, more preferably 5-10 L/min. The stirring speed is 200-1000 rpm, preferably 200-700 rpm, more preferably 200-400 rpm.

Devices to measure and record the physical and hydrodynamic properties of the feed fluid, and hence determine the performance of the first membrane, may be fluidly connected between the feed reservoir and the fluid inlet, between the first receptacle and the fluid outlet, and between the second receptacle and the purified fluid outlet. Examples of these devices include, but not limited to, pressure gauges 110, flowmeters 111, conductivity meters 112, pH meters 113, and temperature sensors 114. Recorded data will allow an ordinary person skilled in the art to calculate parameters, such as efficiency, product recovery, permeate flux, salt rejection, and pressure drop across the membrane, which are specific to the first membrane. The user can then replace the first membrane with a second membrane to evaluate the aforementioned parameters for the second membrane. It is envisioned that the method for comparing two membranes can be extended to a plurality of membranes. In addition, it is envisioned that the membranes can differ in the aforementioned shapes, aforementioned thicknesses, and aforementioned materials. In a preferred embodiment, the membranes have the same shape and thickness, but have different materials.

Valves 115 may be present on the fluid inlet, fluid outlet, and purified fluid outlet to control the flow rate of fluids. Examples of valves include, but are not limited to, ball valves, butterfly valves, globe valves, diaphragm valves, and gate valves. The recovery ratio can be controlled by modifying flow rates of the feed and reject fluids. For brackish water, the recovery ratio is 50-90%, preferably 60-90%, more preferably 70-80%. For seawater, the recovery ratio is 10-50%, preferably 20-50%, more preferably 30-40%. The pressure drop across the membrane will indicate the level of fouling of membrane at fixed recovery ratios.

The performance of the membrane depends on a transmembrane pressure, which is 1-50 bar, preferably 5-40 bar, more preferably 5-35 bar. In at least one embodiment, the pressure produced by the pumping the feed fluid alone will satisfy the required transmembrane pressure. In a preferred embodiment, a gas is needed to pressurize the first interior space through a gas port that is fluidly connected to a gas cylinder. The vessel can withstand pressures up to 140 bar, preferably up to 100 bar, more preferably up to 69 bar. Examples of the gas include, but not limited to, air, argon, and, preferably, nitrogen. In another embodiment, the gas port 116 is attached to the top cover and disposed on the same face as the fluid inlet. In a preferred embodiment, the gas port is connected to the fluid inlet. In a preferred embodiment, a sixth tubing 219 connects the gas port to a gas cylinder 117. The aforementioned materials and dimensions that are relevant to the first tubing also relate to the sixth tubing.

In at least one embodiment, pervaporation is used to create the transmembrane pressure. In one embodiment, a vacuum port fluidly connects the second interior space to a vacuum pump. In another embodiment, the vacuum port fluidly connects the purified fluid outlet to a vacuum pump. In a preferred embodiment, the vacuum port fluidly connects the second receptacle in a closed system to the vacuum pump.

The performance of the membrane is temperature dependent, and the membrane usually filters more effectively at higher temperatures. Therefore, knowing the temperature behavior of membranes will help those skilled in the art to decide on the membrane that will perform under the conditions of use. In at least one embodiment, the vessel is covered with a heating blanket. In another embodiment, the vessel is has a jacket fluidly connected to a heating circulator. The cell can operate in temperatures ranging from 16-80° C., preferably 20-70° C., more preferably 20-60° C.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting the scope of the invention, as well as other claims. The disclosure, including any readily discernible variants of the teachings herein, defines, in part, the scope of the foregoing claim terminology such that no inventive subject matter is dedicated to the public.

1. A desalination cell, comprising:
a vessel, comprising:
a bottom portion, and
a top cover, wherein the bottom portion and the top cover are attached to enclose a first interior space;
a fluid inlet attached to the top cover to fill the first interior space with a feed fluid to be purified;
a fluid outlet attached to the top cover to remove a reject fluid from the first interior space;
an interior unit, comprising:
a membrane to purify the feed fluid to form a purified fluid,
a stirring device to mix the feed and reject fluids, and to reduce caking on a feed side of the membrane,
a first perforated plate to support the stirring device, wherein the first perforated plate is fluidly connected to a feed side of the membrane,
a second perforated plate to support the membrane, wherein the membrane is disposed between the first perforated plate and the second perforated plate, and a permeate side of the membrane is fluidly connected to a first side of the second perforated plate, and a second side of the second perforated plate and interior walls of the vessel enclose a second interior space to contain the purified fluid;
wherein the first perforated plate, the membrane, and the second perforated plate form a fluid tight seal with the interior walls of the vessel; and
a purified fluid outlet that fluidly connects the second interior space to a receptacle;
wherein the desalination cell purifies the feed fluid under cross-flow filtration conditions.

2. The desalination cell of claim 1, wherein the fluid inlet and the fluid outlet are disposed on a side face of the top cover, and the purified fluid outlet is disposed on a side face of the bottom portion.

3. The desalination cell of claim 1, wherein the fluid inlet and the fluid outlet are disposed on a top face of the top cover, and the purified fluid outlet is disposed on a bottom face of the bottom portion.

4. The desalination cell of claim 3, wherein a sealing member is sandwiched between the top cover and bottom portion of the vessel.

5. The desalination cell of claim 1, further comprising a gas inlet disposed on the top cover for adding gas so as to pressurize the first interior space and promote production of the purified fluid.

6. The desalination cell of claim 1, further comprising a vacuum port disposed on the bottom portion of the vessel to create a low pressure region in the second interior space and a high pressure region in the first interior space to promote production of the purified fluid.

7. The desalination cell of claim 1, wherein the feed fluid is a brine solution.

8. The desalination cell of claim 1, wherein the stirring device is a magnet and the cell is disposed on a magnetic stir plate to spin the stirring device to stir the feed fluid and the reject fluid.

9. The desalination cell of claim 1, wherein the membrane is a reverse osmosis desalination membrane.

10. The desalination cell of claim 1, wherein the membrane comprises a polymer or a ceramic material.

11. The desalination cell of claim 10, wherein the membrane comprises a ceramic material, and the ceramic material comprises carbon nanotubes.

12. The desalination cell of claim 1, wherein a diameter of the membrane is 70-95% relative to a largest inner diameter of the bottom portion of the vessel.

13. The desalination cell of claim 1, wherein the membrane is flat.

14. The desalination cell of claim 13, wherein the membrane comprises a ceramic material and has a thickness that is 1-10% relative to a height of the cell.

15. The desalination cell of claim 14, further comprising a sealing member with an inner surface in contact with a circumference of the membrane and an outer surface in contact with the interior walls of the vessel to prevent fluid leakage.

16. The desalination cell of claim 15, wherein the sealing member is a gasket.

17. A water purification method, comprising:
filling the interior space of the desalination cell of claim 1 with the feed fluid through the fluid inlet;
stirring the feed fluid and the reject fluid with the stirring device;
filtering the feed fluid with the membrane, wherein the feed fluid flows through the feed side of the membrane to produce the purified fluid on the permeate side of the membrane and the reject fluid on the feed side of the membrane;
collecting the purified fluid in the receptacle; and
removing the reject fluid through the fluid outlet.

18. The water purification method of claim 17, further comprising adding gas to the interior space to pressurize the first interior space and promote production of the purified fluid.

19. The water purification method of claim 17, further comprising evacuating the second interior space to form a low pressure region in the second interior space and a high pressure region in the first interior space to promote production of the purified fluid.

20. The water purification method of claim 17, further comprising spinning the stirring device, wherein the stirring device is a magnet, with a magnetic stir plate.
